(19) United States
(12) Patent Application Publication
(10) Pub. No.: US 2013/0135897 A1
(43) Pub. Date: May 30, 2013

(54) BACK LIGHT UNIT

(71) Applicants: Daisoung PARK, Pyeongtaek-si (KR); Hyojin LEE, Pyeongtaek-si (KR); Choongyop RHEW, Pyeongtaek-si (KR)

(72) Inventors: Daisoung PARK, Pyeongtaek-si (KR); Hyojin LEE, Pyeongtaek-si (KR); Choongyop RHEW, Pyeongtaek-si (KR)

(21) Appl. No.: 13/359,139

(22) Filed: Jan. 26, 2012

(30) Foreign Application Priority Data
Nov. 28, 2011 (KR) 10-2011-0125295

(51) Int. Cl. G09F 13/18

(52) U.S. Cl. 362/609

(57) ABSTRACT

A backlight unit is provided. The backlight unit includes a light guide panel for guiding light, one or more light sources installed at one side surface of the light guide panel, a reflector sheet installed on a bottom surface of the light guide panel, and an optical sheet installed on a top surface of the light guide panel. A plurality of grooves and pump mountains around the grooves are formed on a top surface of the reflector sheet.

### CROSS REFERENCES

Applicant claims foreign priority under Paris Convention to Korean Patent Application No. 10-2011-0125295 filed Nov. 28,2011, with the Korean Intellectual Property Office, where the entire contents are incorporated herein by reference.

### BACKGROUND OF THE INVENTION

1. Field of the Invention

The present invention relates to a backlight unit. More particularly, the present invention relates to a backlight unit for eliminating spots of a surface light source caused by close adhesion and distance non-uniformity between a reflector sheet and a light guide panel, by forming pump mountains on a top surface of the reflector sheet located on a bottom surface of the light guide panel and spacing the reflector sheet and the light guide panel a constant distance apart.

2. Description of the Related Art

Commonly, a light guide panel, which is a flat plate for providing a path uniformly scattering and diffusing light coming from a light source, is being applied to a light receiving flat display device such as a liquid crystal display device, or a surface light source device used for illumination and the like.

The surface light source device using the light guide panel is widely employing a scheme of arranging a Cold Cathode Fluorescent Lamp (CCFL) or a Light Emitting Diode (LED) as a light source.

A detailed construction and operation of this surface light source device have been disclosed in Korean Patent Application Nos. 1994-33115, 2001-25870, and 2001-53844.

FIG. 1 is a schematic cross section illustrating a construction of a conventional surface light source device.

Referring to FIG. 1, the conventional surface light source device 100 includes a light guide panel 110, a reflector sheet 120 installed on a bottom surface of the light guide panel 110, a light source 130 installed at one sidewall of the light guide panel 110, and a cover member 140 covering the light source 130. The light source 130 can be a Cold Cathode Fluorescent Lamp (CCFL), a Light Emitting Diode (LED), etc. In the light guide panel 110, a plurality of light guide patterns 150 are formed to uniformly guide light incident on the light guide panel 110.

In the conventional surface light source device 100, light irradiated from the light source 130 is incident on the light guide panel 110 and, as indicated by arrows in FIG. 1, the incident light is guided through the light guide panel 110. And then, the light reaches the light guide patterns 150 and gets out of the light guide panel 110. And then, the light reflects from the reflector sheet 120 or just travels upward and passes through a diffuser sheet 160 and a prism sheet 170 arranged on a top surface of the light guide panel 110.

By this, the conventional surface light source device 100 reflects light at a relatively uniform illuminance from each part of the light guide patterns 150.

However, the conventional surface light source device 100 has problems as follows.

The reflector sheet 120 is arranged and used at a distance close to the light guide panel 110 without forming pump mountains on its top surface.

The reflector sheet 120, a relatively thin sheet, easily suffers bending. This bending indicates that there is a distance difference between the light guide panel 110 and the reflector sheet 120.

Particularly, most surface light source devices are used as stood up by a user because of the characteristics of the device. At this time, the reflector sheet 120 composed of the thin sheet suffers bending due to gravity load.

This bending results in local close adhesion and distance difference between the reflector sheet 120 and the light guide panel 110. This close adhesion causes a change of the reflection efficiency of the reflector sheet 120 dependent on position. This is shown as dirty spots when viewing on backlight.

In a case where the light guide panel 110 has an embossed pattern having pump mountains thereon, the spot phenomenon gets weak, however, there is a problem that, in a case where the light guide panel 110 has an engraved pattern having no pump mountains thereon as illustrated in FIG. 1, the spot phenomenon gets more serious.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a backlight unit for eliminating spots of a surface light source caused by close adhesion and distance non-uniformity between a light guide panel and a reflector sheet, by forming pump mountains having predetermined heights on a top surface of the reflector sheet located at a bottom surface of the light guide panel.

According to one aspect of the present invention, a backlight unit is provided. The backlight unit includes a light guide panel for guiding light, one or more light sources installed at one side surface of the light guide panel, a reflector sheet installed on a bottom surface of the light guide panel, and an optical sheet installed on a top surface of the light guide panel. A plurality of grooves and pump mountains around the grooves are formed on a top surface of the reflector sheet.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic cross section illustrating a construction of a conventional surface light source device;

FIG. 2 is an exploded perspective diagram illustrating a backlight unit according to an exemplary embodiment of the present invention;

FIG. 3A is a diagram illustrating a dot pattern formed on a top surface of a reflector sheet according to an exemplary embodiment of the present invention;

FIG. 3B is a diagram illustrating a mesh pattern formed on a top surface of a reflector sheet according to an exemplary embodiment of the present invention;

FIG. 3C is a diagram illustrating a circle pattern formed on a top surface of a reflector sheet according to an exemplary embodiment of the present invention;

FIG. 4A is a diagram illustrating a process of forming pump mountains on a top surface of a reflector sheet using one laser according to a first exemplary embodiment of the present invention;

FIG. 4B is a diagram illustrating a process of forming pump mountains on a top surface of a reflector sheet using two lasers according to a second exemplary embodiment of the present invention;

FIG. 5A is a diagram illustrating shapes of grooves formed to be spaced a predetermined interval apart and shapes of pump mountains formed around the grooves in a laser method according to an exemplary embodiment of the present invention;

FIG. 5B is a diagram illustrating shapes of grooves formed to make a pair per two grooves and shapes of pump mountains formed to make contact in a length direction around the grooves in a laser method according to an exemplary embodiment of the present invention;

FIG. 5C is a diagram illustrating shapes of grooves formed to make a pair per two grooves and shapes of pump mountains formed to make contact in a width direction around the grooves in a laser method according to an exemplary embodiment of the present invention;

FIG. 5D is a diagram illustrating shapes of grooves formed to make a group per three grooves and shapes of pump mountains formed to make contact in a width direction around the grooves in a laser method according to an exemplary embodiment of the present invention;

FIG. 6 is a diagram illustrating a process of forming a pump mountain on a top surface of a reflector sheet in a mold press method according to a third exemplary embodiment of the present invention; and

FIG. 7 is a diagram illustrating a process of forming a pump mountain on a top surface of a reflector sheet in a stamp mold heat press method according to a fourth exemplary embodiment of the present invention.

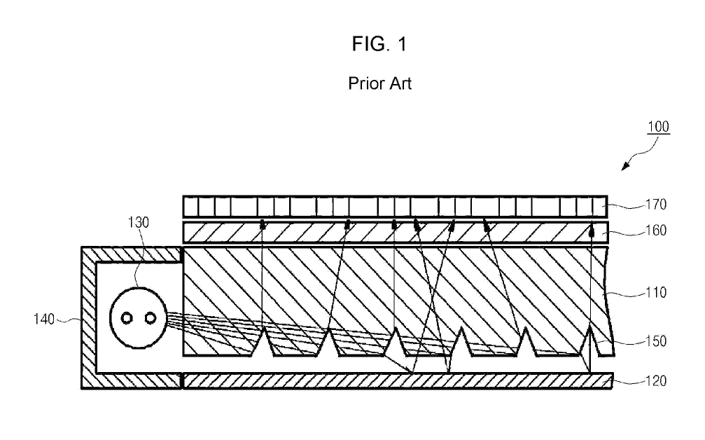

### <Description of Symbols>

| 110: light guide panel | 120: reflector sheet |
|---|---|
| 130: light source | 140: cover member |
| 150: light guide pattern | 160: diffuser sheet |
| 170: prism sheet | 210: light guide panel |
| 220: reflector sheet | |
| 220a, 221, 221a, 221b, 221c: groove | |
| 220a′, 223, 223a, 223a′, 223b, 223b′: pump mountain | |
| 230: diffuser sheet | 240: prism sheet |
| 600: protrusion pattern part | |
| 700: mold pattern | |

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

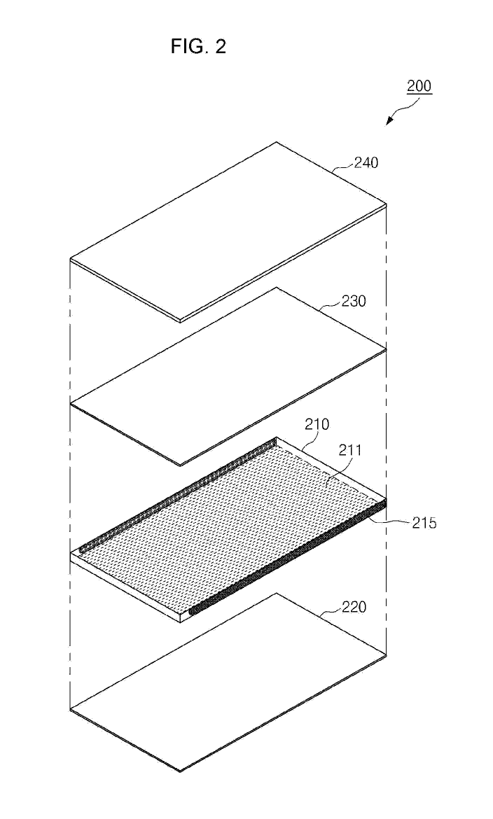

FIG. 2 is an exploded perspective diagram illustrating a backlight unit according to an exemplary embodiment of the present invention.

Referring to FIG. 2, the backlight unit of the present invention includes a light guide panel 210, a reflector sheet 220, a diffuser sheet 230, and a prism sheet 240.

The light guide panel 210 has a light guide pattern 211 of a constant shape on its bottom surface. At least one light source 215 is installed at a sidewall of the light guide panel 210, and scans light to the light guide panel 210.

The reflector sheet 220 is installed on a bottom surface of the light guide panel 210, and reflects incident light upward. The diffuser sheet 230 for scattering and diffusing light and the prism sheet 240 are further installed on a top surface of the light guide panel 210.

Light emitted from the light source 215 is incident on a side surface of the light guide panel 210. In a case where the light is incident less than the critical angle above which the total internal reflection occurs, the light is guided and moved within the light guide panel 210. In a case where the light is incident above the critical angle, the light emits out of the light guide panel 210.

Light emitted from the light guide pattern 211 reflects from the reflector sheet 220 being at a distance from the light guide pattern 211 and having a plurality of pump mountains of predetermined shapes formed thereon, again passes through the light guide panel 210, goes through the diffuser sheet 230 and prism sheet 240 formed on the top surface of the light guide panel 210, and is radiated to the front.

The reflector sheet 220 of the present invention is characterized in that, compared to a conventional reflector sheet, the reflector sheet 220 is less influenced by bending resulting from its own gravity load, by forming a plurality of pump mountains of predetermined shapes on a top surface of the reflector sheet 220 and installing the reflector sheet 220 relatively far away from the light guide panel 210.

At this time, the light guide pattern 211 is arranged to make density low at a pattern part close to the light source 215 and make density high at a pattern part distant from the light source 215, so the backlight unit emitting uniform light is realized.

A description of shapes of the pump mountains formed on the top surface of the reflector sheet 220 and a method for forming the pump mountains is made below in detail.

The present invention forms grooves of constant shapes in the whole region of a top surface of the reflector sheet 220 so that light incident from the light guide panel 210 can reflect more uniformly from the reflector sheet 220.

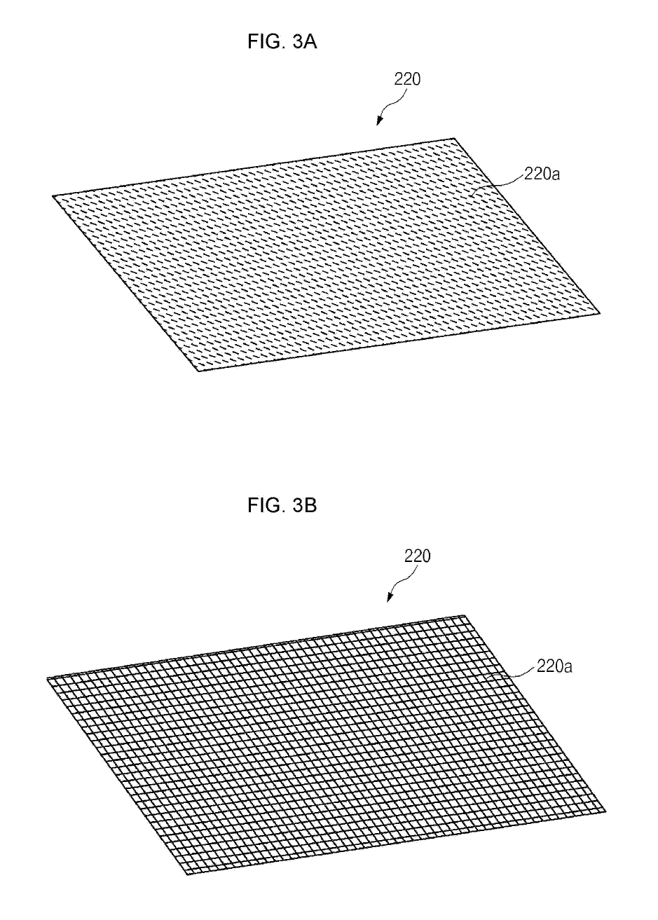

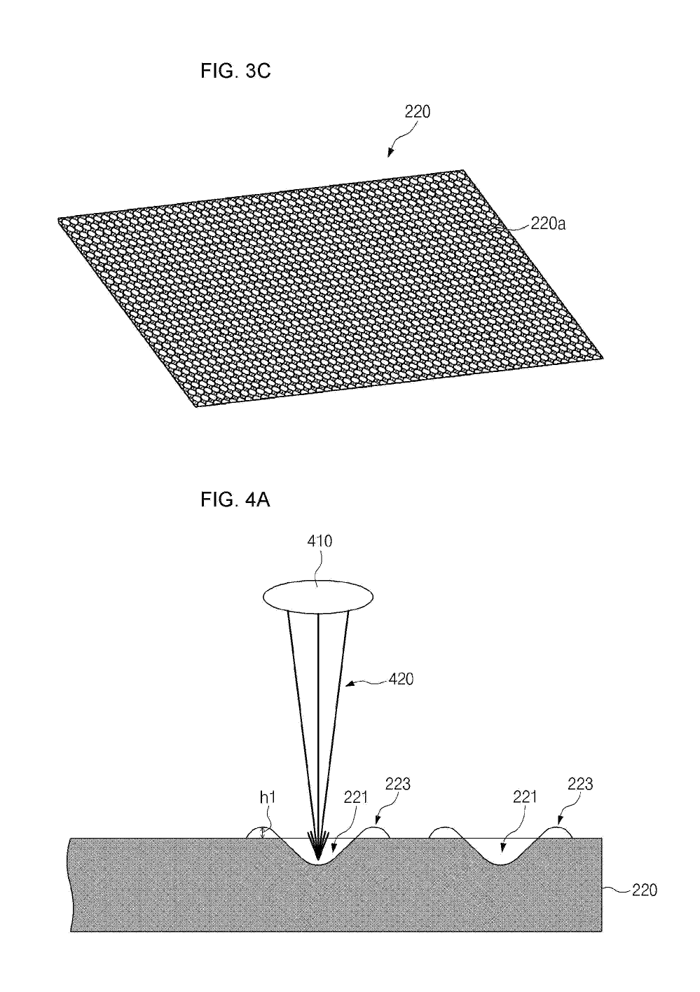

In this case, it is exemplified that the grooves have dot, mesh, and circle shapes as illustrated in FIG. 3A to 3C, but these do not intend to limit the scope of the invention and, undoubtedly, the grooves can be of a dotted line, a straight line, a curve, an oval, a looped curve, a triangle, a square, a polygon or a combination of thereof.

Particularly, in a case where the grooves are of a dot or circle shape, the grooves can be randomly arranged at constant intervals.

In a case where the grooves are sparsely arranged to be of a shape of a plurality of dots in a parallel or serial scheme, the grooves can form a 2 dotted line, a 3 dotted line, or a four or more dotted line.

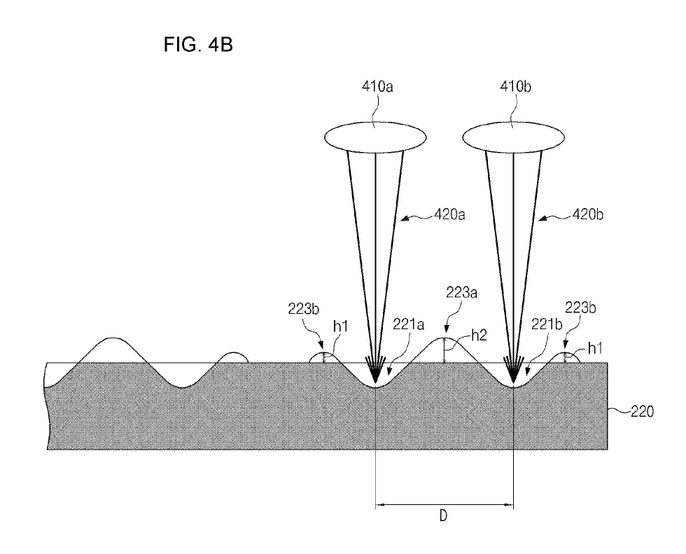

FIG. 4A illustrates a process of forming pump mountains on a top surface of a reflector sheet using one laser according to a first exemplary embodiment of the present invention.

Referring to FIG. 4A, in a case of using one laser, if irradiating a laser beam 420 collected through one focus lens 410 to the center of a groove 221 formed on a top surface of the reflector sheet 220, after laser beam irradiation, a pump mountain 223 is formed by the rise of a fringe of the groove 221.

In this case, there can occur a problem in which an effect of installation of the pump mountain becomes insignificant because a height (h1) of the formed pump mountain 223 is low. To overcome this, a method of increasing laser power or decreasing a laser processing speed can be used. But, this is not desirable at the cost aspect.

Accordingly, as more desirable exemplary embodiment, a second exemplary embodiment is described in FIG. 4B.

FIG. 4B illustrates a process of forming pump mountains on a top surface of a reflector sheet using two lasers according to a second exemplary embodiment of the present invention.

Referring to FIG. 4B, in a state where a pitch between 1st and 2nd grooves 221a and 221b is dense, the present invention can irradiate 1st and 2nd laser beams 420a and 420b collected through 1st and 2nd focus lenses 410a and 410b to the 1st and 2nd grooves 221a and 221b using two lasers, thereby at once forming a pump mountain 223a of a 2nd height (h2) maximally double higher than the 1st height (h1) of the pump mountain 223 formed in the first exemplary embodiment.

In this case, it is desirable that the 2nd height (h2) of the pump mountain 223a is within a range of about 10 μm to 500 μm.

This is because the following problems occur.

Firstly, in a case where the 2nd height (h2) of the pump mountain 223a is less than 10 μm, an effect of forming the pump mountain 223a becomes insignificant.

Secondly, in a case where the 2nd height (h2) of the pump mountain 223a is greater than 500 μm, it is too thick and causes an increase of a thickness of a backlight unit.

Thirdly, to form a high pump mountain, there is a need to process grooves deeply with a laser and, in this case, a reflector sheet is thin and is penetrated.

In the present invention, it was confirmed through various experiments to show the best effects despite machineability, exterior spots and the like when the 2nd height (h2) of the pump mountain 223a is within the range of about 10 μm to 500 μm.

As a method for forming a pump mountain, a method for processing, at a time, a distance between the 1st and 2nd focus lenses 410a and 410b collecting the 1st and 2nd laser beams 420a and 420b in consideration of a distance (D) between the centers of the 1st and 2nd grooves 221a and 221b is exemplified as in FIG. 4B. But, this does not intend to limit the scope of the invention and, as exemplified in FIG. 4A, it is undoubted to be able to perform processing in a scheme of, in turn, irradiating beams to the respective 1st and 2nd grooves 221a and 221b using one laser.

In this case, it was confirmed that the 2nd height (h2) of the pump mountain 223a is maximized when the distance (D) between the centers of the 1st and 2nd grooves 221a and 221b is about 90% to 110% of a line width between the 1st and 2nd grooves 221a and 221b.

In the present invention, it was confirmed that, in a case where the line width is about 250 μm, the 2nd height (h2) of the pump mountain 223a is maximized in a region in which the distance (D) between the centers of the grooves is within a range of about 225 μm to 275 μm.

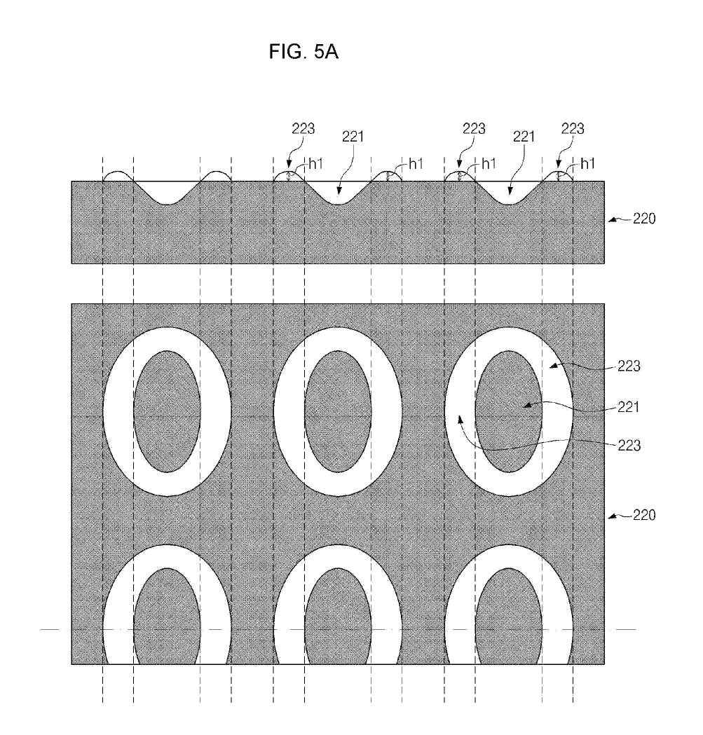

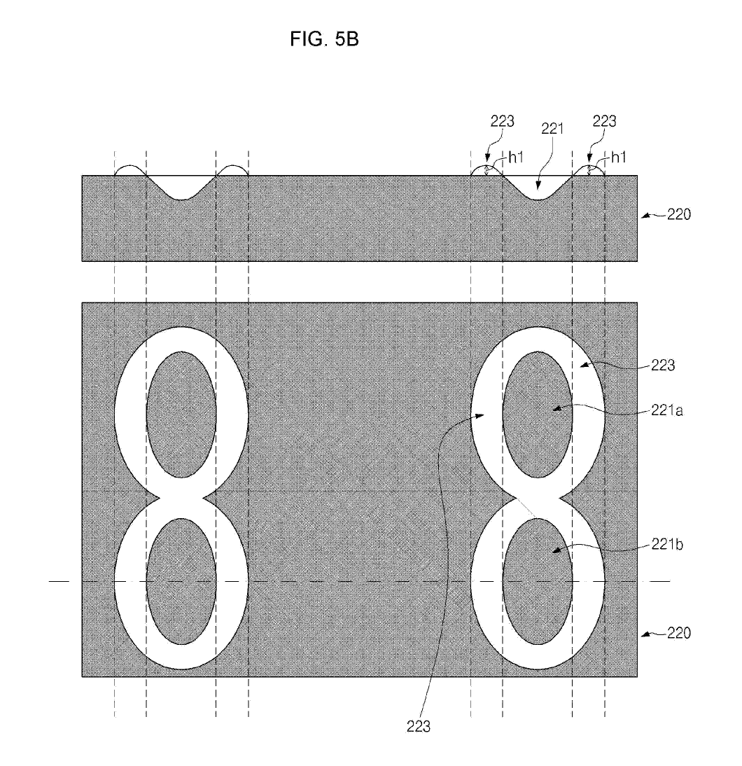

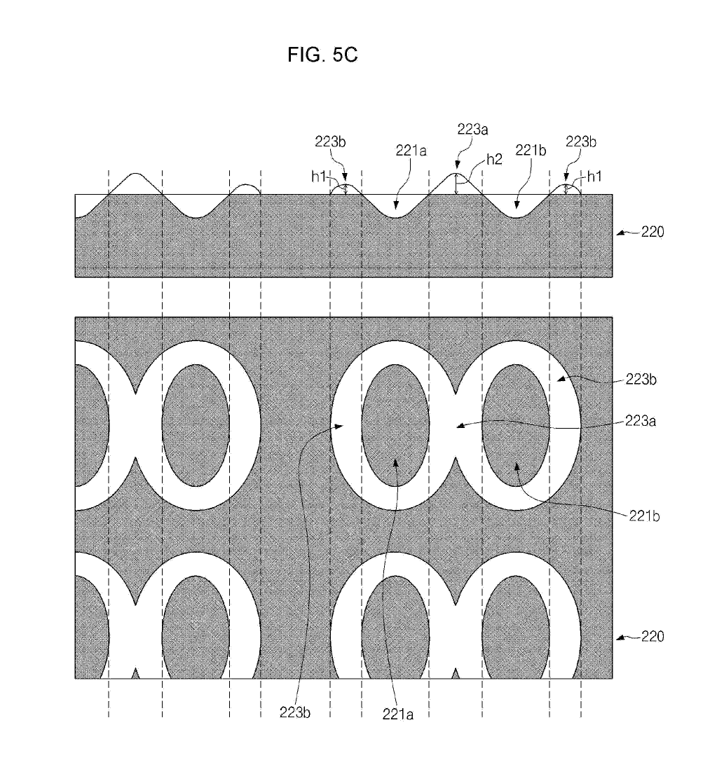

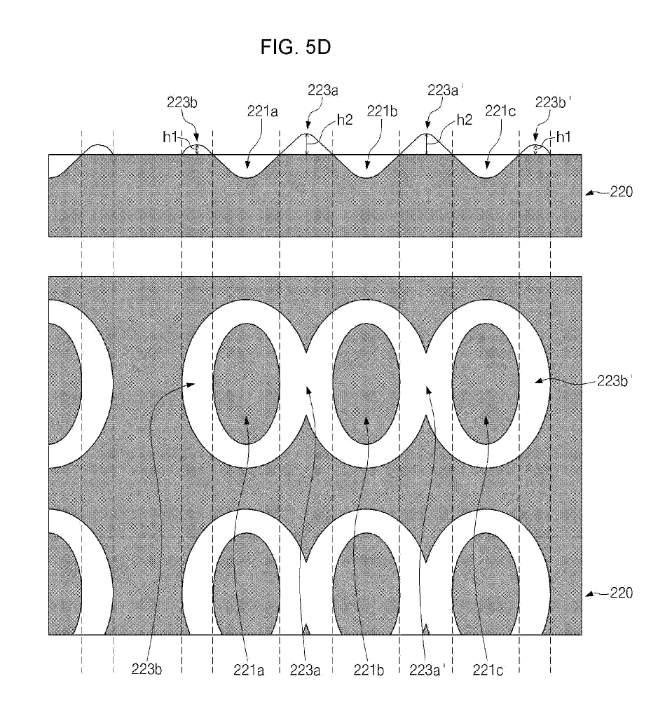

FIGS. 5A to 5D illustrate shapes of grooves realized in a laser method and shapes of pump mountains formed around the grooves according to exemplary embodiments of the present invention.

Referring to FIG. 5A, the present invention forms a pump mountain 223 of a 1st height (h1) using a laser method of FIG. 4A in a state where a plurality of grooves 221 are spaced a predetermined interval apart.

Referring to FIG. 5B, the present invention forms a pump mountain 223 of a 1st height (h1) using a laser method of FIG. 4A in a state where 1st and 2nd grooves 221a and 221b are adhered closely to each other in a length direction.

In FIG. 5B, although not shown in a cross section, a desired pump mountain is formed at a proximity part of a length direction. In this case, it was confirmed that a length of a pattern is more influenced in design than a distance between patterns.

In detail, it was confirmed that a height of a pump mountain is varied according to the design of an end point of a previous pattern and a starting point of a next pattern. Even in this case, the maximum height of the pump mountain can be obtained in a case where a distance between the end point of the previous pattern and the starting point of the next pattern is maintained at 90% to 110% of a line width of a pattern in a pattern design.

Referring to FIG. 5C, the present invention forms a pump mountain 223a of a 2nd height (h2) using a laser method of FIG. 4B in a state where 1st and 2nd grooves 221a and 221b are adhered close to each other in a width direction.

In this case, a proximity part between the 1st and 2nd grooves 221a and 221b forms the pump mountain 223a of the 2nd height (h2) relatively greater than a 1st height (h1), and a non-proximity part forms a pump mountain 223b of the 1st height (h1) relatively less than the 2nd height (h2).

Referring to FIG. 5D, the present invention forms pump mountains 223a and 223a′ each having a 2nd height (h2) using a laser method of FIG. 4B in a state where 1st, 2nd and 3rd grooves 221a, 221b and 221c are grouped to be in close proximity to one another in a width direction, respectively.

Also, parts of the 1st, 2nd and 3rd grooves 221a, 221b and 221c not in close proximity to one another form pump mountains 223b and 223b′ of 1st heights (h1) relatively less than the 2nd height (h2).

Among the terms used in a description of FIGS. 5B and 5D, the width direction is used as meaning a direction having influence on a height of a pump mountain, i.e., meaning a horizontal direction to a height (i.e., vertical direction), and the length direction is used as meaning the same vertical direction as the height (i.e., vertical direction).

On the other hand, a method of forming a groove and a pump mountain can be various methods such as a mold, a stamp using a pin, extrusion, roll press, heat press and the like as well as the aforementioned laser method. Even in this case, undoubtedly, a height of a pump mountain can be more increased due to a grooves proximity effect.

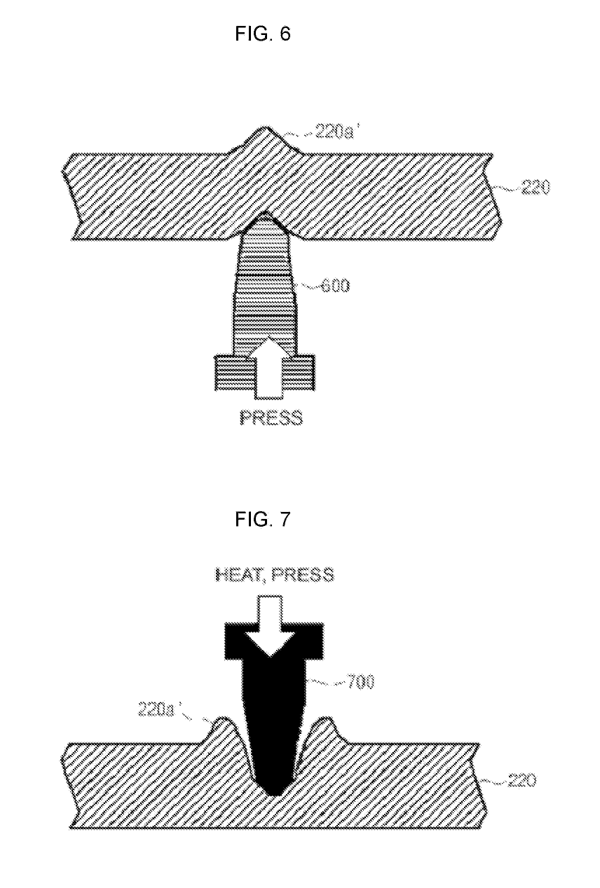

FIG. 6 illustrates a process of forming a pump mountain on a top surface of a reflector sheet in a mold press method according to a third exemplary embodiment of the present invention.

Referring to FIG. 6, the present invention can form a pump mountain on a top surface of a reflector sheet by performing press using a predetermined mold pattern. At this time, in a case of simple press, the present invention can form a pump mountain 220a′ on a top surface of the reflector sheet 220 by performing the simple press to a rear surface of the reflector sheet 220 using a mold with a protrusion pattern part 600.

FIG. 7 illustrates a process of forming a pump mountain on a top surface of a reflector sheet in a stamp mold heat press method according to a fourth exemplary embodiment of the present invention.

Referring to FIG. 7, the present invention can also perform heat press using a predetermined stamp mold. At this time, the present invention can heat and press a mold pattern 700 with a minute needle from a top side, thereby engraving the reflector sheet 220 while forming a pump mountain 220a′ around a groove.

As described above, exemplary embodiments of the present invention have an effect of eliminating spots of a surface light source caused by close adhesion and distance non-uniformity between a reflector sheet and a light guide panel.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A backlight unit comprising:
a light guide panel for guiding light;
one or more light sources installed at one side surface of the light guide panel;
a reflector sheet installed on a bottom surface of the light guide panel; and
an optical sheet installed on a top surface of the light guide panel,
wherein a plurality of grooves and pump mountains around the grooves are formed on a top surface of the reflector sheet.

2. The backlight unit of claim 1, wherein the pump mountain of the reflector sheet is formed such that, in a case where the grooves are paired or grouped, a height of the pump mountain formed by the influence of overlapping of neighboring regions between the paired or grouped grooves is greater than a height of a pump mountain formed without the influence of overlapping of the neighboring regions.

3. The backlight unit of claim 2, wherein the groove pair or group is formed by making two or three grooves in close proximity to one another.

4. The backlight unit of claim 2, wherein a distance between the centers of the grooves spaced apart is 90% to 110% of a line width between the grooves.

5. The backlight unit of claim 1, wherein the grooves are of a shape of dot, mesh, circle, dotted line, straight line, curve, oval, looped curve, triangle, square, polygon, or a combination thereof.

6. The backlight unit of claim 5, wherein, in a case where the grooves are of a shape of dot pair or circle, the grooves are randomly arranged.

7. The backlight unit of claim 5, wherein, in a case where the grooves are of a shape of plural dots, the grooves are sparsely arranged in a form of two-dot line or three-dot line pairing or grouping two or three dots in parallel or in series.

8. The backlight unit of claim 1, wherein a height of the pump mountain is within a range of about 50 μm to 200 μm.

9. The backlight unit of claim 1, wherein the grooves and the pump mountains are formed using a laser processing method.

10. The backlight unit of claim 9, wherein the laser processing method simultaneously irradiates laser beams to the reflector sheet using two or more lasers.

11. The backlight unit of claim 1, wherein the grooves and the pump mountains are formed using any one of mold, stamp, extrusion, roll press, and heat press.
